(19) United States
(12) Patent Application Publication
(10) Pub. No.: US 2018/0300637 A1
(43) Pub. Date: Oct. 18, 2018

(54) DOMAIN KNOWLEDGE INTEGRATION INTO DATA-DRIVEN FEATURE DISCOVERY

(71) Applicant: General Electric Company, Schenectady, NY (US)

(72) Inventors: Weizhong YAN, Clifton Park, NY (US); Tianyi WANG, Clifton Park, NY (US); Achalesh PANDEY, San Ramon, CA (US); Helena GOLDFARB, Niskayuna, NY (US)

(21) Appl. No.: 15/486,571

(22) Filed: Apr. 13, 2017

(51) Int. Cl. G06N 5/04; G06N 99/00

(52) U.S. Cl. CPC G06N 5/04; G06N 99/005

(57) ABSTRACT

The example embodiments are directed to a system and method for integrating domain knowledge into a feature discovery process. In an example, the method includes receiving data associated with an operation of an asset, receiving domain knowledge associated with a subject matter of the asset, performing a feature discovery process based on the received data using the domain knowledge to generate a feature set associated with the operation of the asset, wherein the feature discovery processes reduces a search space of possible features in the received data based on the domain knowledge when generating the feature set, and performing an analytic associated with the operation of the asset based on the domain-knowledge-integrated feature set and outputting information concerning results of analytic for display to a display device. By injecting domain knowledge into the feature discovery process, more accurate features can be identified more efficiently.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include healthcare machines and equipment that aid in diagnosing patients such as imaging devices (e.g., X-ray or MRI systems), monitoring devices, and the like. The design and implementation of these assets often considers both the physics of the task at hand, as well as the environment in which such assets are configured to operate.

Low-level software and hardware-based controllers have long been used to drive machine and equipment assets. However, the rise of inexpensive cloud computing, increase in sensor capabilities, decrease in sensor costs, and the proliferation of mobile technologies have generated new opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

When developing data-driven analytics solutions using data such as time-series data from machine and equipment assets, or any other kind of data, good features can be important to predictive models and can greatly influence results that are going to be achieved by these models. In these examples, a feature refers to a piece of information that might be useful for prediction. Any attribute could be a feature if it is useful to the model or in solving a problem associated with the model. In most cases, the better the features, the better the results/analysis of the model. Therefore, discovering the right features can produce simpler more flexible models that often yield better results. However, identifying optimal features for a given data or problem can be very difficult because there are often thousands of possible features that can be calculated using various algorithms and variables. Accordingly, what is needed is a tool for improving feature discovery.

### SUMMARY

Embodiments described herein improve upon the prior art by providing a hybrid approach that allows for integrating domain-knowledge into data-driven techniques for feature discovery. In one example, the system described herein may receive an incoming signal sensed from or about an asset, transform the signal into frequency data in the frequency domain, and perform feature discovery about an operation of the asset based on the domain knowledge, for example, a specific frequency band that carries more significant information than others, to generate an enhanced feature set associated with the asset. The enhanced feature set may be input into one or more analytics which can be used to monitor and control the asset. The integrated domain knowledge can greatly reduce the search space in the feature discovery process thereby making the feature discovery process more accurate and more efficient. In some aspects, the method can be implemented as software that is deployed on a cloud platform such as an Industrial Internet of Things (IIoT).

In an aspect of an embodiment, provided is a method of integrating domain knowledge within a feature discovery process, the method including receiving data associated with an operation of an asset, receiving domain knowledge associated with a subject matter of the asset, performing a feature discovery process based on the received data using the domain knowledge to generate a feature set associated with the operation of the asset, wherein the feature discovery processes reduces possible features in the received data based on the domain knowledge when generating the feature set, and performing an analytic associated with the operation of the asset based on the domain-knowledge-integrated feature set and outputting information concerning results of analytic for display to a display device.

In an aspect of another embodiment, provided is computing system for integrating domain knowledge within a feature discovery process, the computing system including a receiver configured to receive data associated with an operation of an asset and domain knowledge associated with a subject matter of the asset, and a processor configured to perform a feature discovery process based on the received data using the domain knowledge to generate a feature set associated with the operation of the asset, wherein the feature discovery processes reduces possible features in the received data based on the domain knowledge when generating the feature set, wherein the processor is further configured to perform an analytic associated with the operation of the asset based on the domain-knowledge-integrated feature set and output information concerning results of analytic for display to a display device.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud-computing environment associated with industrial systems in accordance with an example embodiment.

FIG. 2 is a diagram illustrating a feature discovery process pipeline incorporating domain knowledge in accordance with an example embodiment.

FIG. 3 is a diagram illustrating a process of integrating domain knowledge into a current step of a feature discovery process in accordance with an example embodiment.

FIG. 4 is a diagram illustrating a method for performing feature discovery based on domain knowledge in accordance with example embodiments.

FIG. 5 is a diagram illustrating a computing device for performing feature discovery based on domain knowledge in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown.

Traditionally, feature engineering is a pure knowledge based approach and is performed manually by domain experts, which is not only time-consuming, and thus not scalable, but also ineffective and limited. In literature, there exist numerous data-driven techniques that allow engineers to discover salient features directly from data examples. However, those data-driven techniques can be effective only when a large and well-distributed number of data examples are available. In most real-world applications, especially in asset condition monitoring applications, well distributed data examples are rarely available. Rather, there are often very few “event” samples while samples at normal operating conditions are abundantly available. As a result, pure data-driven techniques can be ineffective.

The example embodiments provide a hybrid approach that allows for integrating domain-knowledge into data-driven techniques for effective feature discovery. One of the primary challenges in feature engineering is finding a good set of features can be a search problem because the search space is typically massive and an objective function is not easily identified or solved via closed-form analytics. Furthermore, the overall quality of a feature set is not easily evaluated because many factors can affect it, and it can also require many processes, which prevents the objective function (quality) of the optimization from being evaluated effectively via closed form analytics. To address these problems, the example embodiments provide a system and method that integrates domain knowledge into data driven feature discovery approaches. As a result, more effective features can be identified for any given analytics problem resulting in a more accurate and reliable analytics feature discovery process.

The feature discovery process described herein that incorporates domain knowledge may include software that may be implemented as an application or a service and which may be incorporated within an industrial system or cloud environment such as within a control system, a computer, a server, a cloud platform, a machine, an equipment, a vehicle, a locomotive, an aircraft, a smart structure, and the like. For example, the feature discovery process may be used within predictive analytics, as an enabler for a digital twin simulation process or a brilliant manufacturing process, or the like, however, embodiments are not limited thereto. Predictive analytics may generate models that are based on a relation between a particular performance of a unit in a sample and one or more known attributes or features of the unit. The objective of the model is often to assess the likelihood, or otherwise predict whether a similar unit in a different sample will exhibit the same performance.

While progress with machine and equipment automation has been made over the last several decades, and assets have become ‘smarter,’ the intelligence of any individual asset pales in comparison to intelligence that can be gained when multiple smart devices are connected together, for example, in the cloud. As described herein, an asset is used to refer to equipment and/or a machine used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

For example, an asset can be outfitted with one or more sensors configured to monitor respective operations or conditions thereof. Data from the sensors can be added to the cloud platform. By bringing such data into a cloud-based environment, new software applications and control systems informed by industrial process, tools and expertise can be constructed, and new physics-based analytics specific to an industrial environment can be created. Insights gained through analysis of such data can lead to enhanced asset designs, enhanced software algorithms for operating the same or similar assets, better operating efficiency, enhanced feature evaluation, and the like.

Assets described herein can include or can be a portion of an Industrial Internet of Things (IIoT). An IIoT can connect assets including machines and equipment, such as turbines, jet engines, healthcare machines, locomotives, oil rigs, and the like, to the Internet and/or a cloud, or to each other in some meaningful way such as through one or more networks. The examples described herein can include using a “cloud” or remote or distributed computing resource or service. The cloud can be used to receive, relay, transmit, store, analyze, or otherwise process information for or about one or more assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

However, the integration of assets with the remote computing resources to enable the IIoT often presents technical challenges separate and distinct from the specific industry and from computer networks, generally. A given machine or equipment based asset may need to be configured with novel interfaces and communication protocols to send and receive data to and from distributed computing resources. Assets may have strict requirements for cost, weight, security, performance, signal interference, and the like, in which case enabling such an interface is rarely as simple as combining the asset with a general purpose computing device. To address these problems and other problems resulting from the intersection of certain industrial fields and the IIoT, embodiments provide a cloud platform that can receive and deploy applications from many different fields of industrial technologies.

The Predix™ platform available from GE is a novel embodiment of an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of assets can be uniquely situated to leverage its understanding of assets themselves, models of such assets, and industrial operations or applications of such assets, to create new value for industrial customers through asset insights.

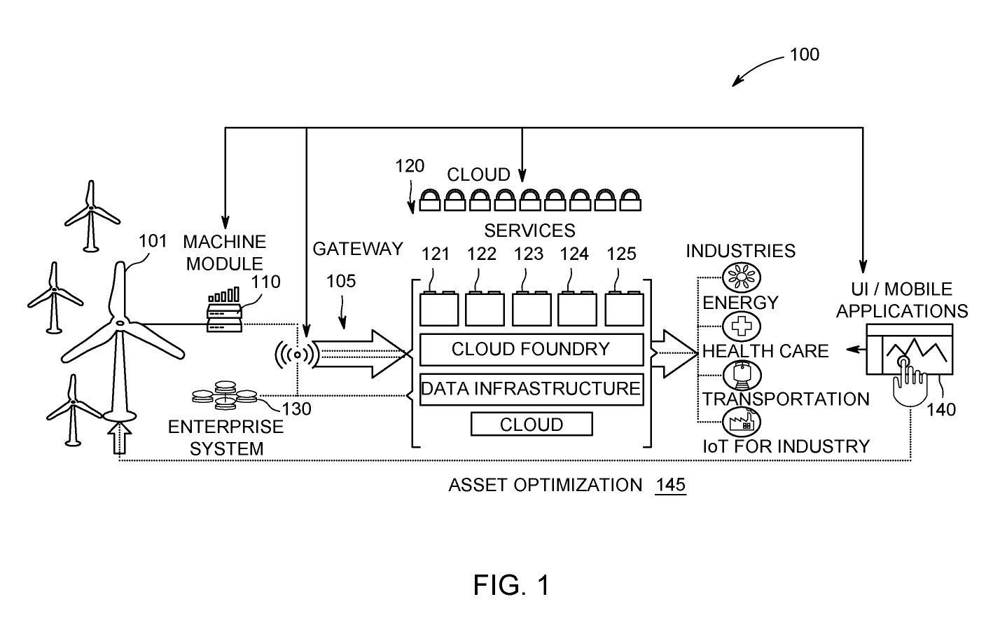

FIG. 1 illustrates a cloud computing environment associated with industrial systems which may implement the feature discovery process described herein. FIG. 1 generally illustrates portions of an asset management platform (AMP) 100. As further described herein, one or more portions of an AMP can reside in a cloud computing system 120, in a local or sandboxed environment, or can be distributed across multiple locations or devices. The AMP 100 can be configured to perform any one or more of data acquisition, data analysis, or data exchange with local or remote assets, or with other task-specific processing devices. The AMP 100 includes an asset community (e.g., gas turbines, wind turbines, healthcare machines, industrial systems, manufacturing systems, oil rigs, etc.) that is communicatively coupled with the cloud computing system 120. In an example, a machine module 110 receives information from, or senses information about, at least one asset member of the asset community, and configures the received information for exchange with the cloud computing system 120. The machine module may be coupled to the cloud computing system 120 or to an enterprise computing system 130 via a communication gateway 105.

The communication gateway 105 may include or may use a wired or wireless communication channel that extends at least from the machine module 110 to the cloud computing system 120. The cloud computing system 120 may include several layers, for example, a data infrastructure layer, a cloud foundry layer, and modules for providing various functions. In FIG. 1, the cloud computing system 120 includes an asset module 121, an analytics module 122, a data acquisition module 123, a data security module 124, and an operations module 125, but the embodiments are not limited thereto. Each of the modules includes or uses a dedicated circuit, or instructions for operating a general purpose processor circuit, to perform the respective functions. In an example, the modules 121-125 are communicatively coupled in the cloud computing system 120 such that information from one module can be shared with another. In an example, the modules 121-125 are co-located at a designated datacenter or other facility, or the modules 121-125 can be distributed across multiple different locations.

An interface device 140 (e.g., user device, workstation, tablet, laptop, appliance, kiosk, and the like) can be configured for data communication with one or more of the machine module 110, the gateway 105, and the cloud computing system 120. The interface device 140 can be used to access analytical applications deployed on the cloud computing system 120 to monitor or control one or more assets. The feature discovery process according to various embodiments may be implemented within the applications for monitoring and controlling these assets. The interface device 140 may also be used to develop and upload applications to the cloud computing system 120. In an example, information about the asset community may be presented to an operator at the interface device 140. The information about the asset community may include information from the machine module 110, information from the cloud computing system 120, and the like. The interface device 140 can include options for optimizing one or more members of the asset community based on analytics performed at the cloud computing system 120.

The example of FIG. 1 includes the asset community with multiple wind turbine assets, including the wind turbine 101. However, it should be understood that wind turbines are merely used in this example as a non-limiting example of a type of asset that can be a part of, or in data communication with, the first AMP 100. Examples of other assets include gas turbines, steam turbines, heat recovery steam generators, balance of plant, healthcare machines and equipment, aircraft, locomotives, oil rigs, manufacturing machines and equipment, textile processing machines, chemical processing machines, mining equipment, and the like.

FIG. 1 further includes the device gateway 105 configured to couple the asset community to the cloud computing system 120. The device gateway 105 can further couple the cloud computing system 120 to one or more other assets or asset communities, to the enterprise computing system 130, or to one or more other devices. The AMP 100 thus represents a scalable industrial solution that extends from a physical or virtual asset (e.g., the wind turbine 101) to a remote cloud computing system 120. The cloud computing system 120 optionally includes a local, system, enterprise, or global computing infrastructure that can be optimized for industrial data workloads, secure data communication, and compliance with regulatory requirements.

The cloud computing system 120 can include the operations module 125. The operations module 125 can include services that developers can use to build or test Industrial Internet applications, and the operations module 125 can include services to implement Industrial Internet applications, such as in coordination with one or more other AMP modules. In an example, the operations module 125 includes a microservices marketplace where developers can publish their services and/or retrieve services from third parties. In addition, the operations module 125 can include a development framework for communicating with various available services or modules. The development framework can offer developers a consistent look and feel and a contextual user experience in web or mobile applications. Developers can add and make accessible their applications (services, data, analytics, etc.) via the cloud computing system 120.

Information from an asset, about the asset, or sensed by an asset itself may be communicated from the asset to the data acquisition module 123 in the cloud computing system 120. In an example, an external sensor can be used to sense information about a function of an asset, or to sense information about an environment condition at or near an asset. The external sensor can be configured for data communication with the device gateway 105 and the data acquisition module 123, and the cloud computing system 120 can be configured to use the sensor information in its analysis of one or more assets, such as using the analytics module 122. Using a result from the analytics module 122, an operational model can optionally be updated, such as for subsequent use in optimizing the first wind turbine 101 or one or more other assets, such as one or more assets in the same or different asset community. For example, information about the wind turbine 101 can be analyzed at the cloud computing system 120 to inform selection of an operating parameter for a remotely located second wind turbine that belongs to a different asset community.

The cloud computing system 120 may include a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration can be useful when an application requires an underlying hardware configuration. The provisioning management and pooling of resources can be done at a granular level, thus allowing optimal resource allocation. In addition, the asset cloud computing system 120 may be based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The cloud computing system 120 can include a data services module that can facilitate application development. For example, the data services module can enable developers to bring data into the cloud computing system 120 and to make such data available for various applications, such as applications that execute at the cloud, at a machine module, or at an asset or other location. In an example, the data services module can be configured to cleanse, merge, or map data before ultimately storing it in an appropriate data store, for example, at the cloud computing system 120. A special emphasis may be placed on time series data, as it is the data format that most sensors use.

Raw data may be provided to the cloud computing system 120 via the assets included in the asset community and accessed by applications deployed on the cloud computing system 120. During operation, an asset may transmit sensor data to the cloud computing system 120 and prior to the cloud computing system 120 storing the sensor data, the sensor data may be filtered and analyzed using the feature discovery process described herein to generate more efficient and accurate analyzations and predictions of the data. In some embodiments, the feature discovery process may be implemented as a software program stored within the cloud computing system 120, or another device such as a computer incorporated with the asset itself, the enterprise computing system 130, the interface device 140, or another device not shown in FIG. 1.

Having a set of good features is the key to high prediction performance (accuracy and robustness) of predictive models. Thus, discovering salient features is a critical task in creating machine learning & data mining models as well as in developing reliable analytics solutions. The example embodiments are directed to a system and method for effectively and efficiently discovering salient features. More specifically, the system and method may intelligently integrating domain or engineering knowledge into the process of feature discovery (e.g., feature generation and feature selection). Such integration not only makes finding the true optimal features possible, but also enables feature discovery to be completed in a reasonable and practical time. The system and method disclosed here is also general, that is, it can be applied to a wide range of applications.

Domain knowledge can be provided from any number of sources. For example, domain knowledge may represent opinions of a subject matter expert for a particular subject matter such as a field of technology or with respect to an asset, a problem, a machine or equipment failure, a component, and the like. The domain knowledge may be generated by an analytic or another automated process that is capable of analyzing current data and rendering a subject matter expert opinion based on previous or historical data in a same or similar subject matter. For example, the analytic may identify variables, algorithms, processes, settings, and the like, which can enhance the feature discovery process of a particular situation. As another example, the domain knowledge may be provided from a user input where the user is a domain expert or subject matter expert such as an engineer, a technician, and the like.

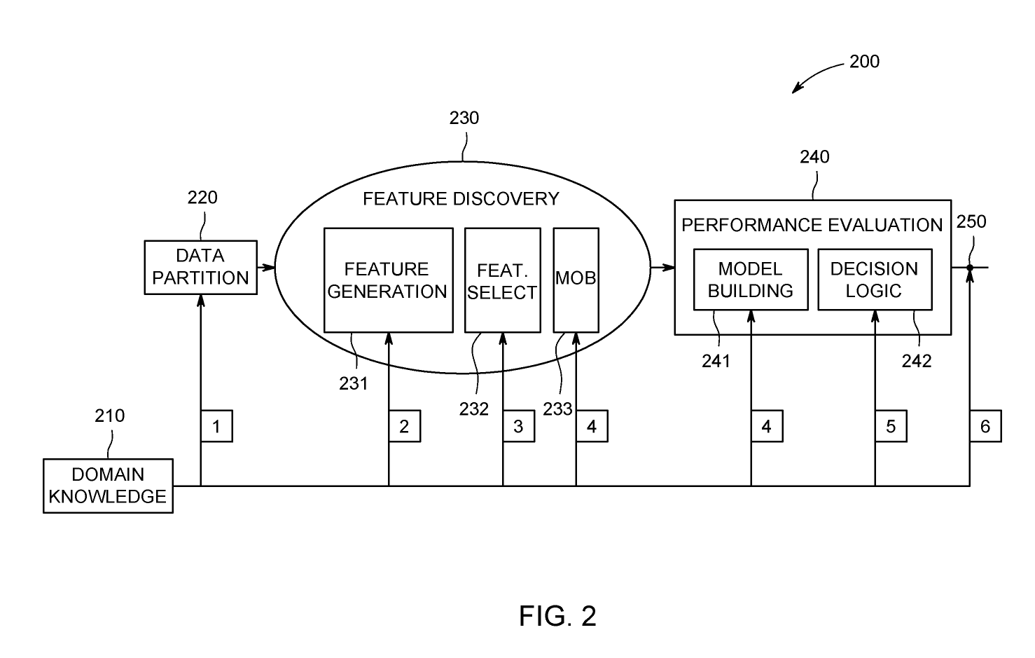

FIG. 2 illustrates a feature discovery process 200 that incorporates domain knowledge in accordance with an example embodiment. Discovering a good set of features may be viewed as a search or optimization problem. In a general data set provided from an asset or other source, data is often not well distributed but is abundantly present around an area of expected behavior. As a result, there are not many events or anomalies that can be used for training purposes. In some cases, analytically evaluating an objective function of the behavior of the asset or other source becomes very difficult and purely data-driven optimization approaches may not work well.

Referring to FIG. 2, a feature discovery pipeline is shown and includes several different functional building blocks, including data partitioning 220, feature discovery 230 and performance evaluation 240. In this example, an output 250 may include a feature set that is generated based on the feature discovery pipeline and used for various purposes including analytics such as predictive analytics for controlling and/or monitoring an asset. In the example of FIG. 2, the feature discovery block 230 further includes a feature generation 231, a feature selection 232, and modeling 233. In addition, the performance evaluation 240 includes model building 241 and decision logic 242. However, it should be appreciated that feature discovery process 230 may not include each of these functions and/or may include additional different functions.

In this example, each step of the process involves multiple possible design choices as well as different design parameters associated with each of the design choices. For a given problem or application, designing a feature discovery pipeline is essential in order to find the best design choices and the corresponding design parameters for each of the processes of the pipeline by searching across all instantiations (all combinations of design choices and their corresponding design parameters). However, this huge combinatorial search space makes optimization computationally expensive and impractical in real-world applications. Plus, the objective function of the optimization may not be easily evaluated. As the result, discovering features through analytical optimization is practically impossible.

For example, during data partition 220, a partition method may be provided from domain knowledge based on an asset associated with the feature discovery process or a time. The data may be transformed from the time domain into the frequency domain where features can be generated. During the feature generation 231, domain based features, constraints, variables, feature generation algorithms, and the like, may be provided from domain knowledge. Furthermore, a sanity check may be performed on the generated features based on domain knowledge. During the feature selection 232, feature filtering criteria, subset selection criteria, feature suggestions, feature evaluation, visualization of features, suggested adjustments for feature generation, and the like, can be provided based on domain knowledge. During the modeling 233 and the model building 241, the domain knowledge may provide requirements on modeling techniques to reduce a search space. During the decision logic 242, domain knowledge may provide business decision logic and its parameters. Furthermore, when the signal is output 250, domain knowledge may provide multi-criteria results and choose a final solution for feature discovery.

According to various aspects, domain knowledge 210 may be incorporated into the feature discovery process for reducing the search space. Specifically, at each of the processes in the pipeline as shown in FIG. 2, choices can be optimized and/or reduced based on injected domain knowledge supplied from a source such as an analytic or even a user. While not all of the processes are required for all problems and applications, and the complication level of such local optimization can vary from one process to another, examples of tasks at each local step may include: 1) choose local criteria that is approximately aligned with a global objective; 2) search for a predetermined number of top choices for the process (e.g., one, two, three, four or more) based on local criteria and make recommendations; and 3) use domain knowledge to choose the top choice based on the recommendation.

It should be appreciated that domain knowledge 210 can be incorporated at each of the six steps shown, however, the embodiments are not limited thereto. For domain knowledge 210 to be incorporated, a user interface (not shown) can be provided on a screen and can receive input from a domain expert device and apply the input to the feature discovery process to improve the feature identification. To facilitate the knowledge integration in the local optimization at each step, the user interface may visually provide intermediate results at each stage and receive input for interactively injecting domain knowledge. Additionally, for each step of the pipeline, problem-dependent default settings or choices may be initially set in case that domain knowledge is not available. As another example, an interface such as an application programming interface (API) can be connected to a domain expert analytical application and can receive domain knowledge from the analytical application. As another example, a built-in automated expert system (ES) can automatically make design recommendations at each step based on the characteristics of problem given at hand.

Feature mapping may be performed by the application herein by converting raw sensor data (e.g., time-series) to feature space. There are many ways to convert raw data to feature space. As a result, an entire feature set in the feature space may be too big (e.g., thousands or even hundreds of thousands of features) which can complicate any modeling being performed based on the sensor data. The example embodiments incorporate domain knowledge into the feature discovery process to down-select useful features from the overall feature set. By down-selecting a small subset of useful features may be selected from among a large number of features. In the example of FIG. 2, the feature generation step 231 (feature generation) generates features and feature selection 232 may be used to select specific features from among the generated features that are of interest.

The system and method herein may incorporate or otherwise integrate domain knowledge 210 throughout the pipeline shown in FIG. 2 which illustrates examples of where in the process domain knowledge can be integrated. Different knowledge may be integrated in different ways. Finding features is an optimization problem where the goal is to find an optimum feature discovery process which is near impossible. By integrating domain knowledge, the search space is reduced providing an improved opportunity to find better or even the best generation/selection for the specific problem. Ultimately, the domain knowledge reduces the search space to find the better features in comparison to a global search space.

After the feature set is generated and output in 250, the feature set may be used for any number of processes including analytics (e.g., predictive analytics associated with an operation of an asset) and the like. The feature set may be an input into a program or application that is used to execute tests or other simulations on the asset and generate results. The results may be output to a display device. The feature discovery process provided herein solves the problem of integrating domain knowledge into the process of feature engineering and discovery. With the domain-knowledge integrated, it is possible to discover useful features for any given analytics problem. Thus, more accurate and reliable analytics solutions based on those features can be developed. According to various embodiments, analytics may be performed to monitor, analyze, and predict the behavior of an asset. In some cases, data from the physical asset may be monitored and in some cases data from a virtual asset corresponding to the physical asset can be monitored. Analytics can generate alerts, warnings, and the like, when an asset beings performing irregularly. Analytics can also be used to predict the future behavior of assets enabling corrective action to be taken before issues arise with the asset such as maintenance, part replacement, and the like.

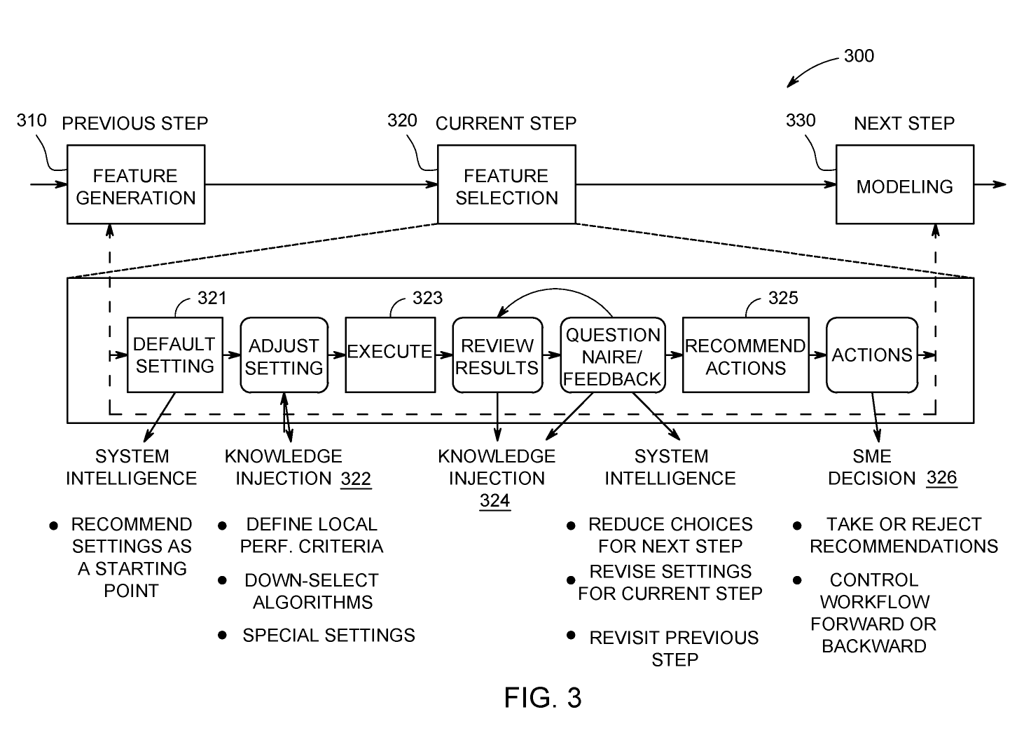

FIG. 3 illustrates a process 300 of integrating domain knowledge into a current step of a feature discovery process in accordance with an example embodiment. This example process 300 may be applied to any of the six steps included in the feature discovery process 200 shown in FIG. 2. For purposes of example, FIG. 3 illustrates an example of the feature selection processes (i.e., 230 in FIG. 2) as a current step 320 with the feature generation step being a previous step 310 and the modeling step being the next step 330.

Referring to FIG. 3, in the current step 320, default settings 321 or default values for an algorithm or previous set parameters may be initially applied. The default settings 321 may be the settings that were applied during the previous step 310. Domain knowledge 322 from a subject matter expert or an analytic may be injected into the process to adjust the default settings 321 causing the amount of available features to be down-selected for feature selection (e.g. satisfying a local selection criteria for the feature selection, etc.). As another example, the domain knowledge 322 may be a down-select algorithm based on various parameters of the algorithm.

In step 323, one or more feature selection algorithms can be executed to generate results produced by the process. In response, in 324, the domain knowledge provider may review the results and provide feedback to the process (e.g., through the user interface) by selecting various options or responding to questions through selection of GUI components such as drop down boxes, lists, radio buttons, and the like. Here, the domain knowledge may be used to provide feedback to the process based on subject matter expert findings. In 325, the process may recommend one or more actions to be taken, accordingly. Recommended actions may include going back to a previous step, adjusting a current step, going to the next step with the recommended setting, etc. These actions may be recommended and relied on by the domain expert (e.g., SME, analytic, algorithm, etc.) to make a decision in 326.

An example of the process 300 performed in FIG. 3 may include doing feature selection based on a generic algorithm. Here, the default settings may be the default settings for variables in the generic algorithm. The domain knowledge may be injected into the process to adjust the parameters of the generic algorithm to make it more accurate, more efficient, and/or the like. The adjusted algorithm can be executed to find one or more sets of features, each representing one choice of feature selection. The domain expert may view the features that are found and determine which features to use based on the problem/meaning, which might be regardless of actual performance. However, the examples are not limited hereto and may include many different possible examples.

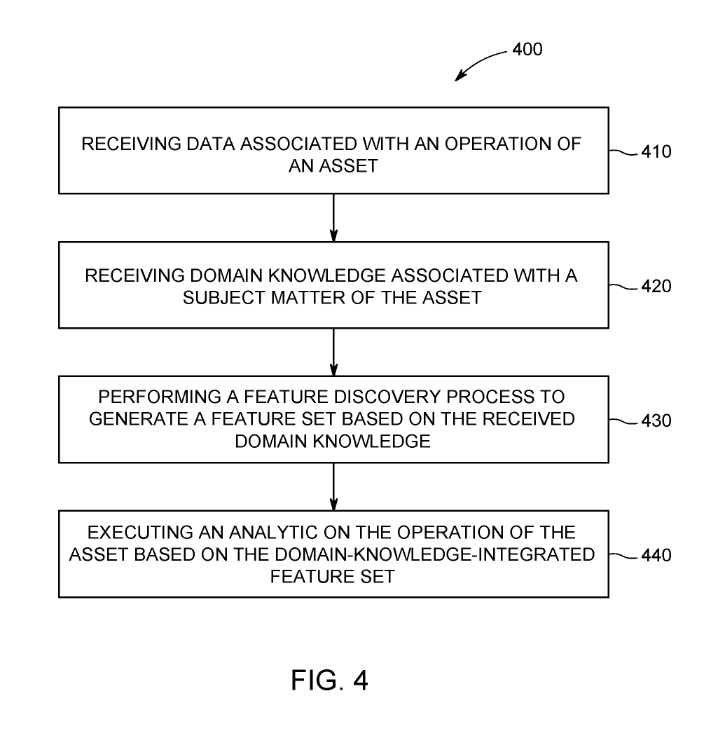

FIG. 4 illustrates a method 400 of performing feature discovery based on domain knowledge in accordance with example embodiments. For example, the method 400 may be performed by one or more devices within the cloud computing system 100 shown in FIG. 1, or another device such as a user device, a server, or the like. Referring to FIG. 4, in 410, the method includes receiving data associated with an operation of an asset. For example, the data may be associated with a physical asset or a virtual asset corresponding to a physical asset. An asset may be a machine or an equipment used in at least one of manufacturing, transportation, energy acquisition, and healthcare. For example, an asset can be a wind turbine, an oil platform, a jet engine, a locomotive, a crane, a power plant, a sub-station, a manufacturing equipment, a healthcare machine (e.g., scanning, imaging, etc.), and the like.

In 420, the method includes receiving domain knowledge associated with a subject matter of the asset. For example, the domain knowledge may include an expert's opinion or selection of a particular variable, parameter, algorithm, feature, criteria, and the like, associated with a particular step of the feature discovery process. The domain knowledge may be provided from an automated software application such as a built-in expert or an analytical application that makes determinations based on historical data of previous subject matter expert opinions. As another example, the domain knowledge may be input by a domain expert via a user interface, or the like.

The method further includes performing a feature discovery process based on the received data using the domain knowledge to generate a feature set associated with the operation of the asset, in 430. For example, the feature discovery process may reduce possible features in the received data based on the domain knowledge when generating the feature set. The feature discovery process may include a multi-step process that includes feature generation, feature selection from among features generated during the feature generation, performance evaluation of the selected features, and the like. In this example, the received domain knowledge may be injected into the feature generation to modify an algorithm that is used to generate features, into the feature selection to provide criteria for selecting features from among the features generated during the feature generation, into the performance evaluation to provide at least one of modeling techniques and decision logic, for evaluating the selected features, and/or the like.

In 440, the method includes performing an analytic associated with the operation of the asset based on the domain-knowledge-integrated feature set and outputting information concerning results of analytic for display to a display device. Here, the analytic may be a predictive analytic that monitors and outputs data about future predictions associated with the asset or the operation of the asset. As another example, the feature set may be used to train an analytic or to train a machine learning algorithm.

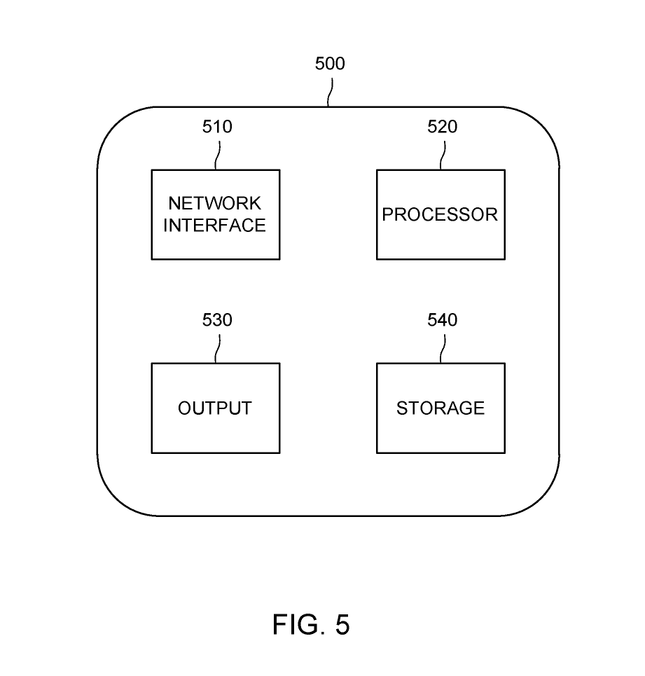

FIG. 5 illustrates a computing device 500 for performing feature discovery based on domain knowledge in accordance with an example embodiment. For example, the computing device 500 may be a user device such as a computer, laptop, mobile device, tablet, etc., a server, a cloud computing system, and the like. The computing device 500 may perform the method 400 of FIG. 5. Referring to FIG. 5, the computing device 500 includes a network interface 510, a processor 520, an output 530, and a storage device 540. Although not shown in FIG. 5, the device 500 may include other components such as a display, an input unit, a receiver/transmitter, and the like. In this example, the processor 520 may control the overall operation of one or more of the components of the computing device 500 or may be substituted for one or more of the components.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like.

According to various embodiments, the network interface 510 may receive data associated with an operation of an asset and domain knowledge associated with a subject matter of the asset. For example, the data may be received from one or more sensors attached to the asset. The data may be time domain data or it may be converted into the frequency domain. The domain knowledge may be received from an analytical application that auto-generates subject matter expert opinions, a built-in domain expert software program, a user input, and the like.

In some embodiments, the processor 520 may convert the data into the frequency domain. The processor 520 may perform a feature discovery process based on the received data using the domain knowledge to generate a feature set associated with the operation of the asset. For example, the feature discovery process may reduce or otherwise refine an amount of possible features in the received data based on the domain knowledge when generating the feature set. Furthermore, the processor 520 may perform an analytic associated with the operation of the asset based on the domain-knowledge-integrated feature set and output information concerning results of analytic for display to a display device.

According to various aspects, the feature discovery process executed by the processor 520 may include a multi-step process that includes feature generation, feature selection from among features generated during the feature generation, and performance evaluation of the selected features. Also additional steps may be included. Here, the processor 520 may inject the received domain knowledge into the feature generation to modify an algorithm that is used to generate features, into the feature selection to provide criteria for selecting features from among the features generated during the feature generation, and/or into the performance evaluation to provide at least one of modeling techniques and decision logic, for evaluating the selected features.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to various examples of the application. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, interne of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A method of integrating domain knowledge within a feature discovery process, the method comprising:
receiving data associated with an operation of an asset;
receiving domain knowledge associated with a subject matter of the asset;
performing a feature discovery process based on the received data using the domain knowledge to generate a feature set associated with the operation of the asset, wherein the feature discovery process reduces a search space of possible features in the received data based on the domain knowledge when generating the feature set; and
performing an analytic associated with the operation of the asset based on the domain-knowledge-integrated feature set and outputting information concerning results of analytic for display to a display device.

2. The method of claim 1, wherein the feature discovery process comprises a multi-step process that includes feature generation, feature selection from among features generated during the feature generation, and performance evaluation of the selected features.

3. The method of claim 2, wherein the received domain knowledge is injected into the feature generation to at least one of choose feature generation algorithms, provide feature generation algorithms, and specify parameters in feature generation algorithms, in order to generate more relevant and salient features.

4. The method of claim 2, wherein the received domain knowledge is injected into the feature selection to at least one of provide criteria for selecting features from among the features generated during the feature generation, choose feature selection algorithms and their parameters, and provide feedback for the selected features.

5. The method of claim 2, wherein the received domain knowledge is injected into the performance evaluation to provide at least one of modeling techniques and decision logic, for evaluating the selected features.

6. The method of claim 1, wherein the feature discovery process includes the capability of generating recommendations for next actions based on the domain knowledge received and the data received.

7. The method of claim 1, wherein the domain knowledge is received from a built-in domain expert software program.

8. The method of claim 1, wherein the received data is sensed from an asset comprising a machine or an equipment used in at least one of manufacturing, transportation, energy acquisition, and healthcare.

9. A computing system for integrating domain knowledge within a feature discovery process, the computing system comprising:
a receiver configured to receive data associated with an operation of an asset and domain knowledge associated with a subject matter of the asset; and
a processor configured to perform a feature discovery process based on the received data using the domain knowledge to generate a feature set associated with the operation of the asset, wherein the feature discovery process reduces a search space of possible features in the received data based on the domain knowledge when generating the feature set; and
wherein the processor is further configured to perform an analytic associated with the operation of the asset based on the domain-knowledge-integrated feature set and output information concerning results of analytic for display to a display device.

10. The computing system of claim 9, wherein the feature discovery process executed by the processor comprises a multi-step process that includes feature generation, feature selection from among features generated during the feature generation, and performance evaluation of the selected features.

11. The computing system of claim 10, wherein the processor injects the received domain knowledge into the feature generation to at least one of choose feature generation algorithms, provide feature generation algorithms, and specify parameters in feature generation algorithms, in order to generate more relevant and salient features.

12. The computing system of claim 10, wherein the processor injects the received domain knowledge into the feature selection to provide at least one of criteria for selecting features from among the features generated during the feature generation, choose feature selection algorithms and their parameters, and provide feedback for the selected features.

13. The computing system of claim 10, wherein the processor injects the received domain knowledge into the performance evaluation to provide at least one of modeling techniques and decision logic, for evaluating the selected features.

14. The computing system of claim 9, wherein the feature discovery process includes the capability of generating recommendations for next actions based on the domain knowledge received and the data received.

15. The computing system of claim 9, wherein the domain knowledge is received from a built-in domain expert software program.

16. The computing system of claim 9, wherein the received data is sensed from an asset comprising a machine or an equipment used in at least one of manufacturing, transportation, energy acquisition, and healthcare.

17. A non-transitory computer readable storage medium having stored therein instructions that when executed cause a processor to perform a method of integrating domain knowledge within a feature discovery process, the method comprising:
receiving data associated with an operation of an asset;
receiving domain knowledge associated with a subject matter of the asset;
performing a feature discovery process based on the received data using the domain knowledge to generate a feature set associated with the operation of the asset, wherein the feature discovery process reduces a search space of possible features in the received data based on the domain knowledge when generating the feature set; and
performing an analytic associated with the operation of the asset based on the domain-knowledge-integrated feature set and outputting information concerning results of analytic for display to a display device.

18. The non-transitory computer readable storage medium of claim 17, wherein the feature discovery process comprises a multi-step process that includes feature generation, feature selection from among features generated during the feature generation, and performance evaluation of the selected features.

19. The non-transitory computer readable storage medium of claim 18, wherein the received domain knowledge is injected into the feature generation to at least one of choose feature generation algorithms, provide feature generation algorithms, and specify parameters in feature generation algorithms, in order to generate more relevant and salient features.

20. The non-transitory computer readable storage medium of claim 18, wherein the received domain knowledge is injected into the feature selection to provide at least one of criteria for selecting features from among the features generated during the feature generation, choose feature selection algorithms and their parameters, and provide feedback for the selected features.
